(19) United States
(12) Patent Application Publication
(10) Pub. No.: US 2012/0317479 A1
(43) Pub. Date: Dec. 13, 2012

(54) METHOD AND SYSTEM FOR SHARED DOCUMENT EDITING ON A MOBILE DEVICE

(75) Inventor: John Safa, London (GB)

(73) Assignee: WORKSHARE LTD., London (GB)

(21) Appl. No.: 13/155,900

(22) Filed: Jun. 8, 2011

(51) Int. Cl. G06F 17/21; G06F 3/041

(52) U.S. Cl. 715/256

(57) ABSTRACT

This invention discloses a novel system and method for displaying electronic documents that have been edited by multiple authors. The invention presents edits of each author as a separate overlay on the original document. The display is more convenient and readable for users using mobile devices or tablets to view or modify the electronic document using a touch screen.

### FIELD OF INVENTION

This invention provides a mechanism whereby a group of people operating individual computer devices can view and modify a commonly edited electronic document in a manner more suitable to mobile devices or tablet style computer devices.

### BACKGROUND

Electronic documents, for example text documents, are often subject to revision by more than one author. For example, a group working together on a document may share a document that is stored in a remote location. Each member of the group may have privileges to modify the document. However, the existing electronic document editing programs are not suitable for managing and displaying these changes. Some editing programs simply show all the edits, with the later edits over-writing the earlier edits. Some editing programs show all the edits or none of the edits, rather than selectively presenting the edits by participant. On mobile devices or tablet computers, there is a need for a method and system of group editing of an electronic document whereby the user interface of the computer program permits better control of the group editing process by its participants.

### DESCRIPTION OF THE FIGURES

1. Basic architecture.
2. Basic Flow Chart for Overlay Box
3. Example Original Document presented to a user
4. Version presented to a user where a second user's edits are selected.
5. Display of comments box.
6. Accept or Reject dialogue box.
7. Flow Chart for Accept/Reject Box
8. Flow Chart for view clean function
9. Flow Chart for Flagging
10. Flow Chart for swipe navigation through edits.

### DETAILED DESCRIPTION OF THE PREFERRED EMBODIMENTS

The method and system operates on one or more computers, typically using a server and one or more remote user's computing devices. A customer's device can be a personal computer, mobile phone, mobile handheld device like a Blackberry™ or iPhone™ or a tablet device like the iPad™ or Galaxy™ or any other kind of computing device a user can use to view and edit an electronic document. The user devices are operatively connected to the remote server using a data network. The invention does not require that the data network be in continuous contact with the remote file server.

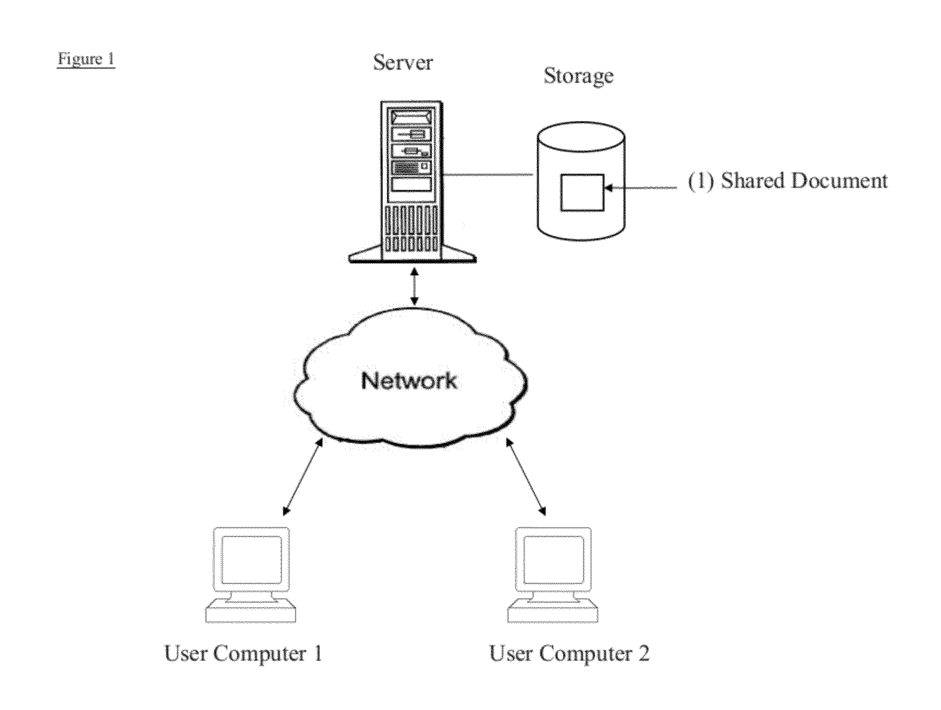

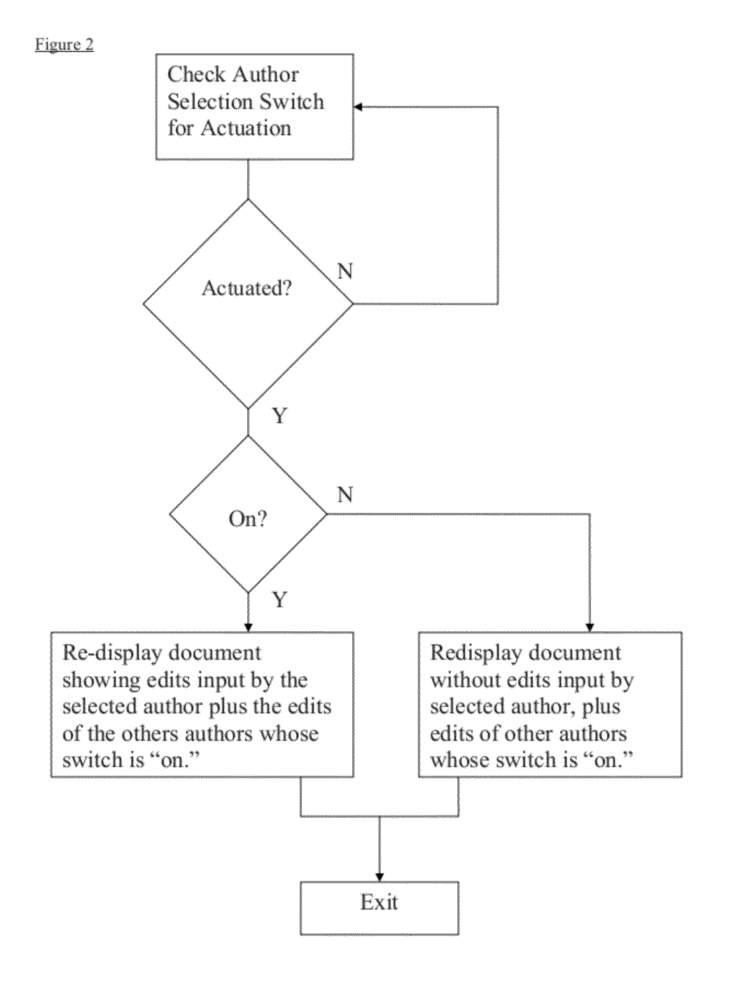

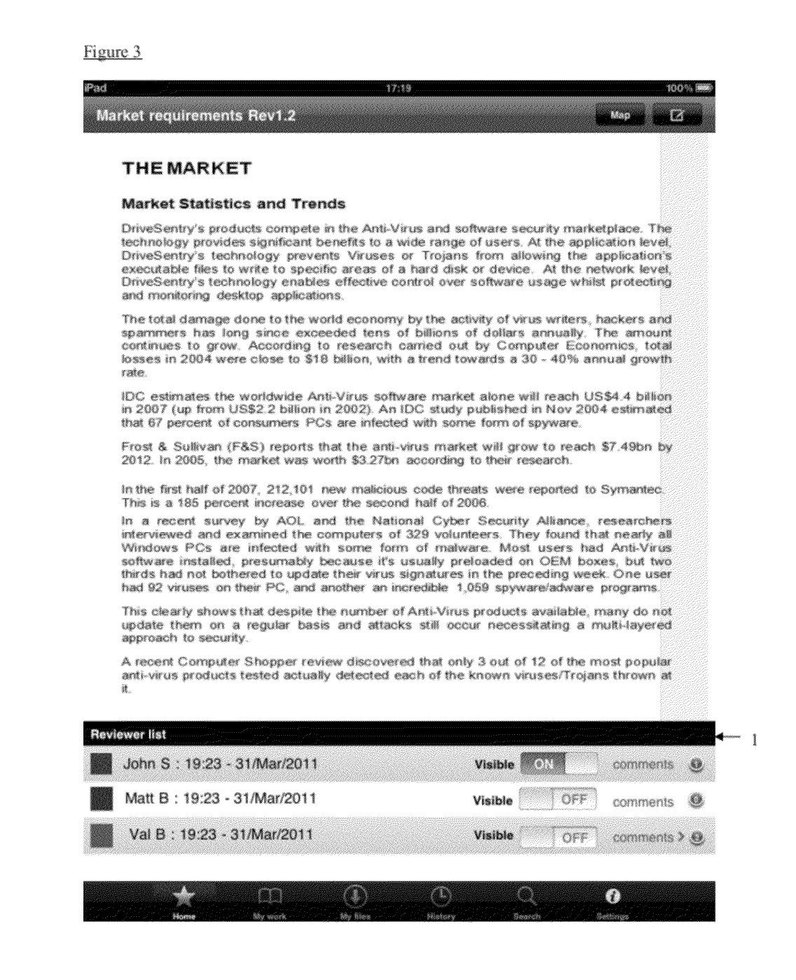

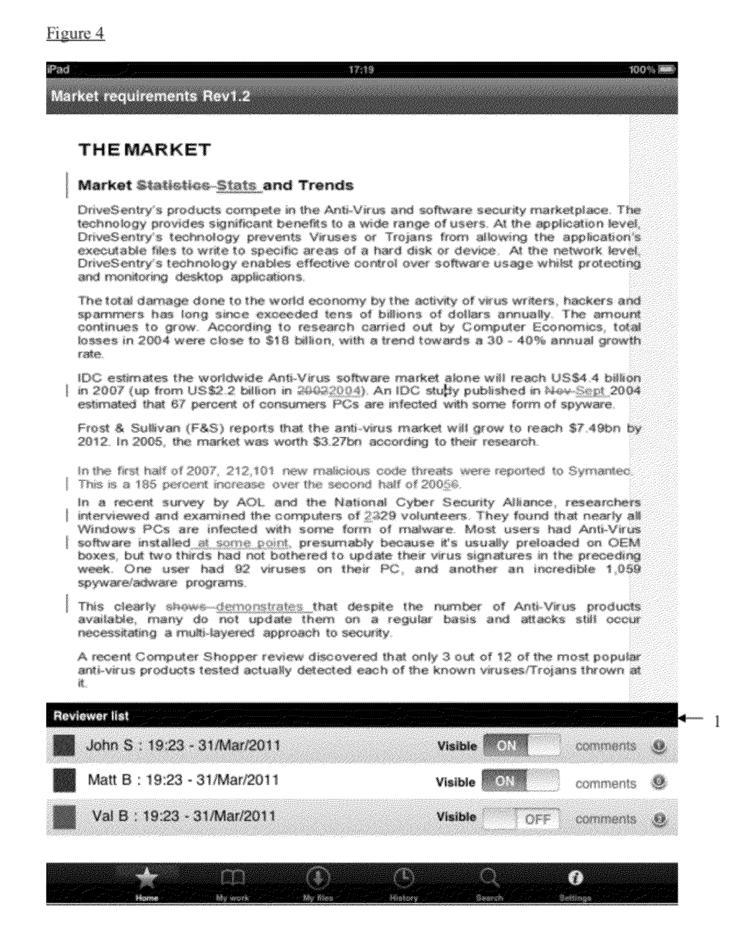

In one embodiment of the invention, the edited document stored on the remote server is downloaded into the user's device. Besides the text and formatting, the document also contains additional data that indicates the presence of edits to the text, their location and content. Edits can be text that is inserted into the original document by an author, or deletions of text from the original document. Insertions, deletions and other changes can also include insertion or deletion of graphics from a document or modifications of the graphics. In addition, the identity of the author (or authors) of the edit (or edits) is (are) encoded in such data. When the downloaded document is displayed on the user's device, the presentation utilizes the invention. Edits can be displayed by means of color text for new text and strike-throughs for deleted text. FIG. 3 shows the original document, with no indication of any edits. The invention causes the identity of the author or authors to be displayed at the bottom of the screen in a dialogue box (1). In the example presented in FIG. 3, three authors are indicated by means of their identifiers. In one embodiment, each author is assigned an editing color. In another embodiment, the overlay type of presentation of group edits obviates the need for different colors. In that embodiment, the same color can be used for all of the authors and the authors' edits selectively turned on and off. In yet another embodiment, for each author displayed in the dialogue box, an image can be displayed in proximity to the author's name or other identifier, for example a picture of the author or some graphic or logo associated with the author. The dialogue box (1) presents a list of the authors, their editing color and a selection switch that causes that author's edits to be displayed. More than one author's selection switch can be activated to an “ON” or viewable state, which means that the edits of that author will be displayed. The switch graphical object can itself display the word “ON”. In addition, fewer than all of the authors' edits may be selected to be displayed. Unlike other electronic document editing programs, the invention presents the edits as overlays on the existing document. The selection switch turns on the overlay associated with each individual author. In the example of FIG. 4, the selection of “John Safa” and “Matt B” to be “ON” causes the edits that according to the meta-data are associated with John Safa and Matt B to be activated and displayed. The system detects that the user has selected the “ON” switch on the user interface and then causes the editing program to execute a process to re-display the document using the edits associated by the document data with the author associated with the selected switch. If the user actuates another author's selection switch from “OFF” to “ON” or from “ON” to “OFF”, the page is re-displayed with that selection applied to the display of text. See FIG. 2.

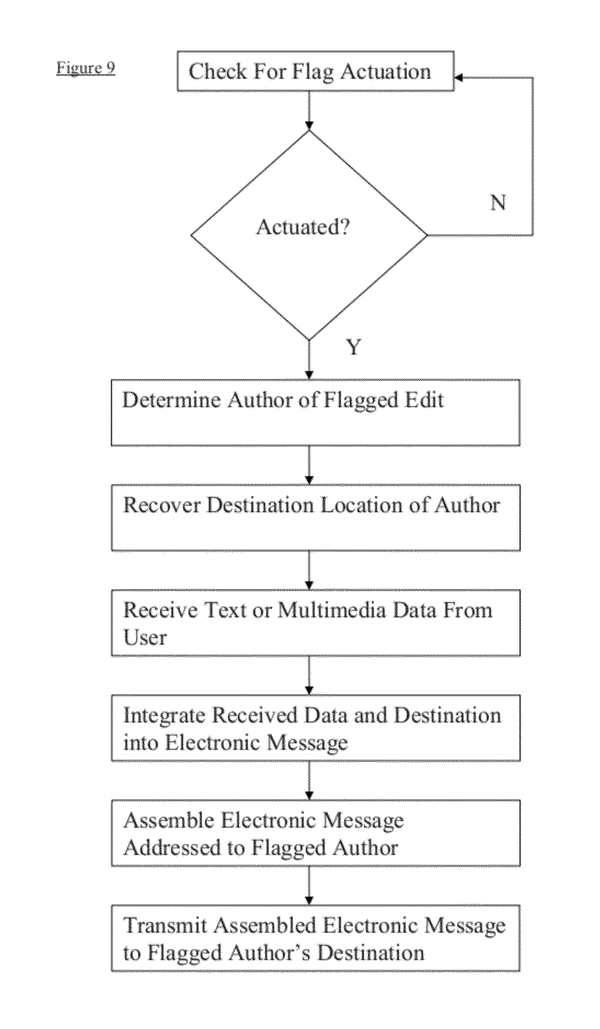

In yet another embodiment, the dialogue box includes selection switches for each author that provide for a provisional acceptance of the edit, that is, showing the document without that author's edits as a markup, but with the selected author's edits applied. See FIG. 8. This provides for easier reading without requiring the user displaying the edited document from accepting the edits while reviewing the document. In this embodiment, the system detects whether or not an authors' edit selection switch has been turned “ON.” If so, the system checks if the user has actuated the button that causes the display to present that author's edits as if they were accepted. The button can be labeled as a “View Clean” button in the dialogue box or some other name. If the system detects that the user has made such an actuation, the system causes the electronic editing program to re-display the document with the selected edits but without using any strike-throughs, underline or colors to indicate the edits, that is, the document is displayed in normal text, that is, as if the selected edits had been accepted into the document. When the View Clean button is deactivated, the system causes the program to re-display the document with the selected edits displayed using the strike-throughs, underlines or colors to indicate the edits.

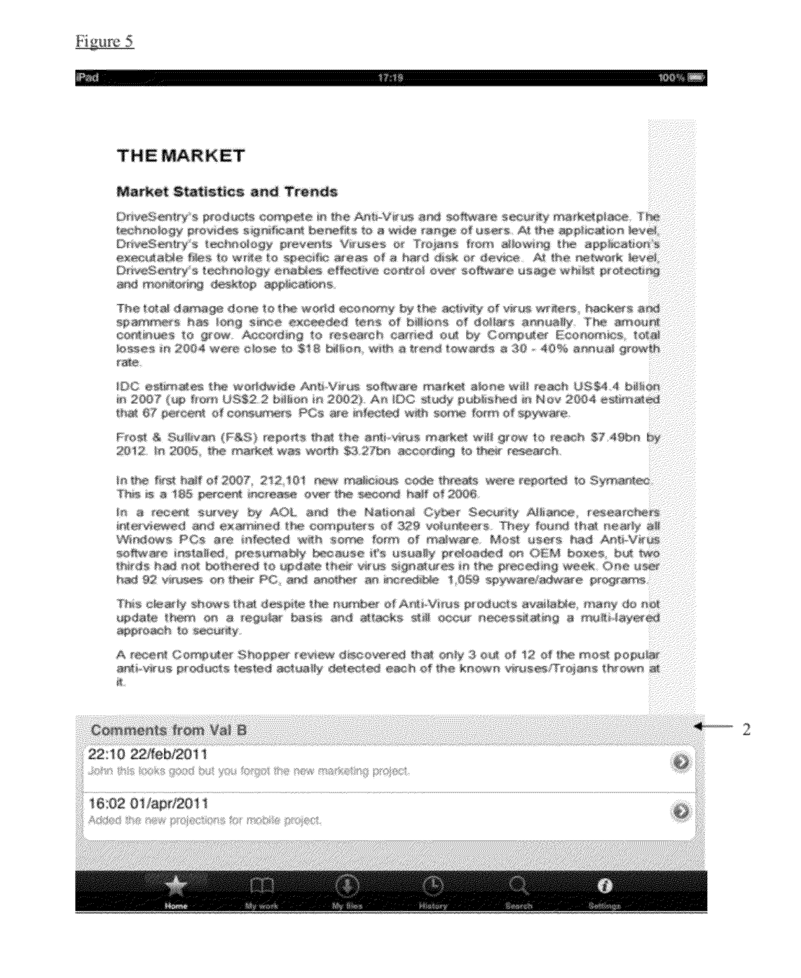

In yet another embodiment, the authors of the document can input into the document comments associated with their identity. In this embodiment, the dialogue box (1) displays a number associated with each author indicating the number of comments that author has input. In this embodiment, the number display can also function as a button on the user interface. When the system detects that a button has been actuated, then the comments associated with the author associated with the actuated button are displayed in a new display box (2) that replaces the dialogue box. See FIG. 5. The display box also contains return arrow buttons that, when the system detects they are actuated, causes the dialogue box (1) to be re-displayed and its user interface activated. The new display box shows the authors comments at the bottom for the selected edit. The display box includes a button that when actuated, causes the program to skip to next comment of that author.

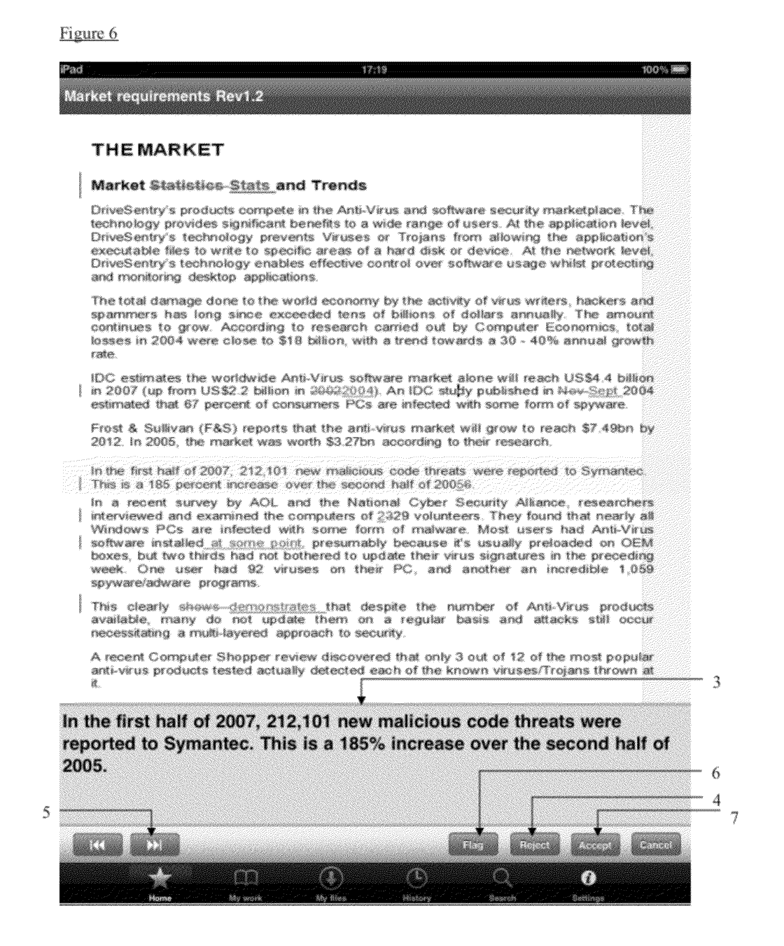

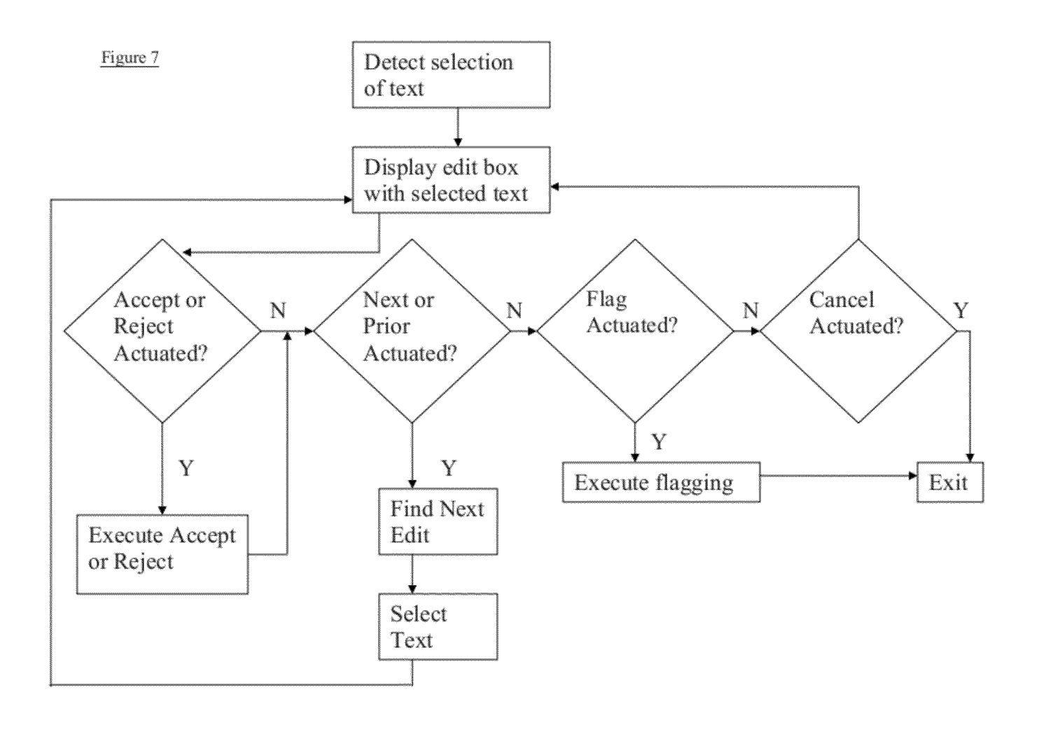

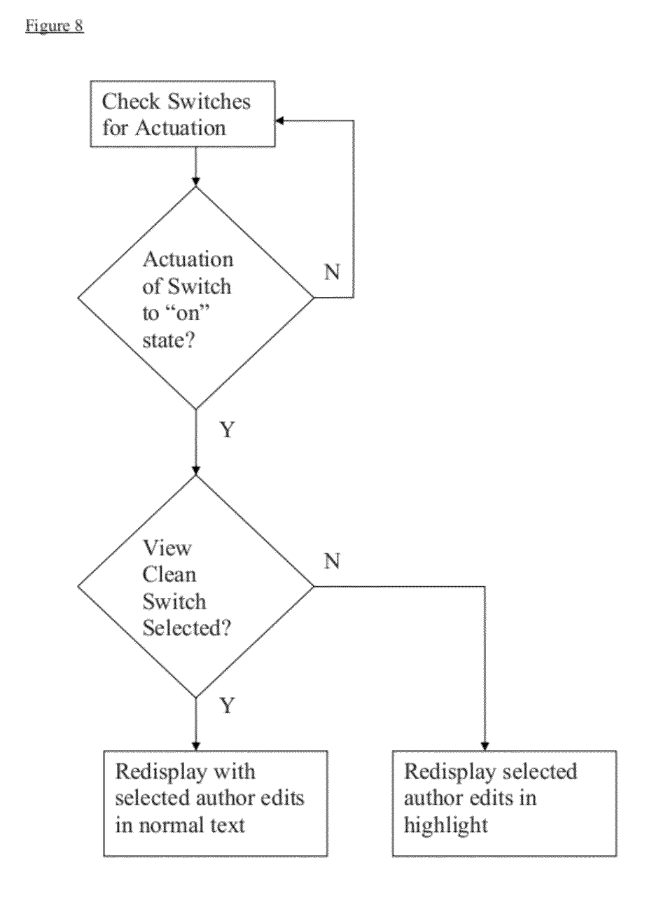

In yet another embodiment, the system can provide a more ergonomic editing interface. In this embodiment, an author that is inputting edits into the document can select a sentence, paragraph or other piece of text. That selection can also be made on the basis of selecting an edit and having the entire sentence the edit is part of further selected. The selection processes causes a new dialogue box to be displayed on the screen (3). See FIG. 6. In this case, the displayed sentence can be presented in a larger type-face or different font. In addition, the sentence can be edited in the new editing dialogue box (3). The editing dialogue box also contains additional buttons that can be selected by the user. (4) One is to accept the edit presented, one is to reject it, one is to flag it, (6) and one to cancel the operation and return to the prior display. See FIG. 7. In yet another embodiment, the editing dialogue box has navigation buttons that permit the user to use one button actuation to move forward or back to the next edited sentence or paragraph. (5) See FIG. 7.

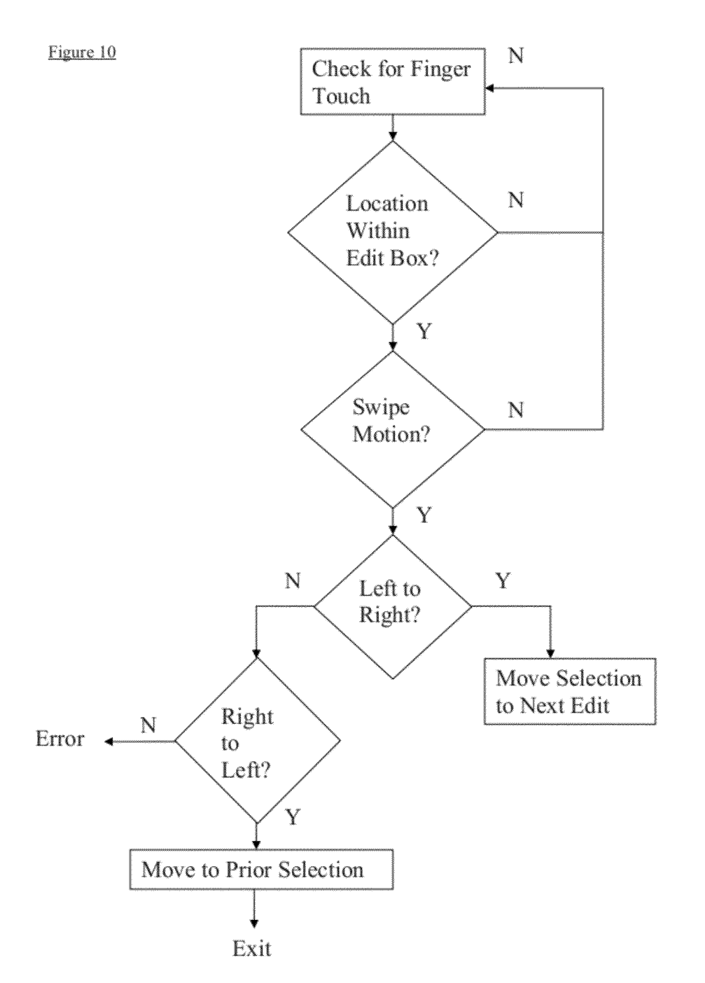

Flagging an edit is a function that creates a message on the device and has the device transmit the message to the author of the edit or all authors. The system contains data storage that is comprised of data including network addresses associated with the authors, for example, an email address, a telephone number, Twitter™ handle or any other designation of an electronic message destination. This data may be stored on the server or on the user devices. When the “flag” button is actuated, the system composes an electronic message that is then transmitted to the destination associated with the author of the edit being flagged. In another embodiment, the message is transmitted to the destinations associated with all of the authors, respectively. The message is a data object that is transmitted to the destination or destinations. The program logic causes the system to fetch from storage the destination data associated with the author of the edit. Then the program assembles the data object using content and the destination data. The content of the message can be comprised of a reference to the document, the edit and the identity of the reviewer that flagged the edit, in the form of text data. In yet another embodiment, the system can cause a dialogue box to open permitting the reviewer to type in a question or comment that is included with the message data object as text data. In yet another embodiment, the device can open a dialogue box that permits the reviewer to record their voice input or voice together with video input as a recording of the reviewer reciting a question or a comment. This audio or audio visual data is then transmitted as part of the content of the message data object, thus alleviating the need for the reviewer to type text data into the message. See FIG. 9.

When the user operating the editing dialogue box actuates the “ACCEPT” button (7), the display returns to the first display with the author dialogue box (1) with the accepted edit placed into the document as accepted text, that is, text that is treated by the document editing program normally. A data message to the server can cause the server to update the document copy stored at the server. In another embodiment, the “ACCEPT” button does not return the program to the first dialogue box (1). Instead, the reviewer can stay in the mode of seeing each edit displayed in larger text at the bottom of the screen as shown in FIG. 6. In this embodiment, the touch-sensitive screen of the device can be utilized to navigate through the document. The system detects whether the reviewer's finger is touching the screen in the region of the screen where the edit is being displayed (3), as explained above. If the system detects that the finger is swiping to the right, in that region, the program then displays the next edit in the document. If the system detects that the finger is swiping to the left, the program displays the prior edit. The sense of right or left can be reversed, or replaced with up and down. In another embodiment, the program logic determines what the “next” or “prior” edit to display is based on which edits have been selected to be displayed in the first dialogue box (1). See FIG. 7. If a particular author's comments are “OFF”, then those edits are not counted for determining which edit in the document is “Next” or “Prior.”

### Operating Environment:

The user's computer may be a laptop, desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and RDA's, multiprocessor systems, microprocessor-based systems, set top boxes, programmable consumer electronics, network PCs, minicomputers, mainframe computers, distributed computing environments that include any of the above systems or devices, and the like.

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments, The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a. RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Modifications of the above disclosed apparatus and methods which fall within the scope of the invention will be readily apparent to those of ordinary skill in the art. Accordingly, while the present invention has been disclosed in connection with exemplary embodiments thereof; it should be understood that other embodiments may fall within the spirit and scope of the invention, as defined by the following claims.

What is claimed:

1. A method executed by a computer comprising a video display of user interaction with an electronic document comprising one or more edits made by one or more corresponding authors comprising:
Displaying on the video display a first window containing graphical objects representing a first set of one or more author selection switches, each said switch associated with a corresponding author and each author associated with corresponding edits in the electronic document;
Determining which of the first set of one or more author selection switches are actuated to a viewable state; and
Displaying the electronic document on the video display screen in a second window using the edits associated with the authors that correspond to the determined first set of selection switches that are in a viewable state.

2. The method of claim 1 further comprising:
Causing the displayed edits to be visible using one or more of: colored text, highlighting, strikethroughs and underlines.

3. The method of claim 2 further comprising:
Displaying on the video display graphical elements representing a second set of one or more selection switches, each said switch associated with a corresponding author;
Determining which of one or more second set of selection switches are actuated to a viewable state;
Causing the displayed edits corresponding to the authors associated with the determined second set of selection switches to be displayed in normal text.

4. The method of claim 1 further comprising:
Displaying a graphic or logo associated with each author in proximity to at least one authors' identifier.

5. The method of claim 1 further comprising:
Displaying one or more graphical objects corresponding to the one or more authors, said graphical objects containing a displayed number representing the number of comments said corresponding author has entered into the document.

6. The method of claim 5 further comprising:
Detecting a selection of an edit displayed in the second window;
Displaying a third window that displays a graphical object comprising text representing one or more authors' comments, said comments corresponding to the selected edit.

7. The method of claim 6 further comprising:
Displaying in the third window a graphical object representing a selection switch that when actuated, causes the second window and third window to display the section of the document comprising the edit corresponding to the commenting author's next comment.

8. The method of claim 1 further comprising:
Detecting a selection of an edit displayed in the second window;
Displaying a fourth window that displays the selected edit in a font size larger than that displayed in the second window;
Displaying in the fourth window at least one graphical object representing one an “accept” switch;
Determining if the “accept” switch has been actuated;
In response to such actuation, causing the selected edit to be inserted into the document as accepted text.

9. The method of claim 8 further comprising:
Determining the presence and direction of a finger swipe in the region of the fourth window;
In dependence on such determination, displaying in the second window, the document section comprising the next edit of the selected author or authors and displaying in the fourth window the next edit.

10. The method of claim 9 where the determined swipe is from left to right.

11. The method of claim 9 where the determined swipe is from up to down.

12. The method of claim 8 further comprising:
Determining the presence and direction of a finger swipe in the region of the fourth window;
In dependence on such determination, displaying in the second window the document section comprising the (prior edit of the selected authors and displaying in the fourth window the prior edit.

13. The method of claim 12 where the determined swipe is from right to left.

14. The method of claim 9 where the determined swipe is from down to up.

15. The method of claim 1 further comprising:
Detecting the selection of an edit;
Displaying a graphical object representing a “flag” switch;
Determining if the “flag” switch has been actuated;
In response to such actuation, assembling an electronic message; and
Transmitting the message to the author associated with the selected edit.

16. The method of claim 15 further comprising:
Receiving text data input;
Inserting said received text data into the electronic message.

17. The method of claim 15 further comprising:
Receiving as data input one or more of audio or video;
Inserting said received audio or video data into the electronic message.

18. The method of claim 15 further comprising:
Transmitting said electronic message to the other authors.

19. The method of claim 9 where the text displayed in the fourth window is larger than the text displayed in the second window.

20. The method of claim 12 where the text displayed in the fourth window is larger than the text displayed in the second window.

21. A system comprised of a computer adapted to perform any of the methods of claims 1-20.

22. A computer readable medium containing computer program code that when run causes the performance of any of the methods of claim 1-20.
